(19) United States
(12) Patent Application Publication
(10) Pub. No.: US 2024/0137819 A1
(43) Pub. Date: Apr. 25, 2024

(54) CROSS LAYER OPTIMIZATION FOR SELECTION OF A BEST CELL FROM CONDITIONAL SPECIAL CELL CHANGE CANDIDATE CELLS

(71) Applicant: APPLE INC., Cupertino, CA (US)

(72) Inventors: Sushant Vikram, San Jose, CA (US); Amr Abdelrahman Yousef A. Mostafa, Munich (DE); Yuanye Wang, San Jose, CA (US); Pradeep S. Sharma, Cupertino, CA (US); Ajay Singh, San Jose, CA (US)

(21) Appl. No.: 18/168,293

(22) Filed: Feb. 13, 2023

Related U.S. Application Data
(60) Provisional application No. 63/380,279, filed on Oct. 20, 2022.

(51) Int. Cl. H04W 36/00; H04W 36/06; H04W 36/30

(52) U.S. Cl. CPC H04W 36/0055; H04W 36/06; H04W 36/30

(57) ABSTRACT

Systems and methods for cross layer optimization for selection of a best or most preferred cell from conditional special cell (SpCell) change candidate cells are disclosed. The conditional SpCell change may be, for example, a conditional handover (CHO) or a conditional primary cell of a secondary cell group (PSCell) change (CPC). Conditions for a conditional SpCell change may be provided to a user equipment (UE). It may be that measurements on multiple cells meet the condition(s) for a conditional SpCell change by the UE. Preferences/criteria for selecting a cell from these multiple compliant candidate cells meeting the conditional SpCell change conditions are discussed herein. These criteria may include, but are not limited to, for example, a cell quality, an inter-versus intra-frequency handover, bandwidth, component carrier (CC) use, band, carrier type, needs/criticality of the application, congestion, frequency range, multiple subscriber identity module (MSIM) considerations, etc.

### CROSS-REFERENCE TO RELATED APPLICATIONS

This application claims the benefit of priority pursuant to 35 U.S.C. § 119(e) of U.S. provisional patent application No. 63/380,279 filed on Oct. 20, 2022 entitled “CROSS LAYER OPTIMIZATION FOR SELECTION OF A BEST CELL FROM CONDITIONAL HANDOVER CANDIDATE CELLS,” which is hereby incorporated by reference in its entirety.

### TECHNICAL FIELD

This application relates generally to wireless communication systems, including wireless communication systems implementing conditional handover mechanisms.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and Institute of Electrical and Electronics Engineers (IEEE) 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

Frequency bands for 5G NR may be separated into two or more different frequency ranges. For example, Frequency Range 1 (FR1) may include frequency bands operating in sub-6 gigahertz (GHz) frequencies, some of which are bands that may be used by previous standards, and may potentially be extended to cover new spectrum offerings from 410 megahertz (MHz) to 7125 MHz. Frequency Range 2 (FR2) may include frequency bands from 24.25 GHz to 52.6 GHz. Note that in some systems, FR2 may also include frequency bands from 52.6 GHz to 71 GHz (or beyond). Bands in the millimeter wave (mmWave) range of FR2 may have smaller coverage but potentially higher available bandwidth than bands in FR1. Skilled persons will recognize these frequency ranges, which are provided by way of example, may change from time to time or from region to region.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1A and FIG. 1B together illustrate a flow diagram for CHO that may be used in some wireless communications systems.

FIG. 2 illustrates a flow diagram for CPC that may be used in some wireless communications systems.

FIG. 3 illustrates a flow diagram for CPC that may be used in some wireless communications systems.

FIG. 4 illustrates a method for optimizing a conditional SpCell change, according to embodiments herein.

FIG. 5 illustrates a method of a UE, according to embodiments herein.

FIG. 6 illustrates an example architecture of a wireless communication system, according to embodiments disclosed herein.

FIG. 7 illustrates a system for performing signaling between a wireless device and a network device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

In some wireless communications systems, a network provides a UE with candidate conditional handover (CHO) cells and/or (in dual connectivity (DC) cases) candidate conditional primary cell of a secondary cell group (PSCell) change (CPC) cells with corresponding measurement identifiers (measIDs) to measure and, if condition(s) of the CHO and/or the CPC are satisfied, perform a corresponding handover/PSCell change to one of the candidate cells meeting the condition. In such cases, the UE performs measurements on the candidate cells, and if one or more of the measurements satisfies CHO/CPC condition then the UE will attempt to perform the handover/the PSCell change (as the case may be).

Herein, discussion of a “conditional special cell (SpCell) change” may be understood to refer to either cases corresponding to a handover under CHO and/or cases corresponding to a PSCell change under CPC. Correspondingly, discussion of a “SpCell change” may be understood to refer to either a handover (e.g., as under CHO) and/or to a PSCell change (e.g., as under CPC). Further, it will accordingly be understood that conditions as discussed herein may be for any type of conditional SpCell change (e.g., may be understood to be conditions for CHO and/or CPC, as the case may be).

In some cases of a conditional SpCell change, it may be that measurements on multiple candidate cells (more than one candidate cell) meet the applicable condition for the conditional SpCell change. In some wireless communications systems, a mechanism for selecting one of these multiple compliant candidate cells with which to perform a corresponding SpCell change is undefined.

Cross layer optimizations for conditional SpCell change described herein may be used for selecting which cells to measure (e.g., a measurement priority mechanism) and/or (e.g., once measurements are received) determining a prioritization for which of multiple candidate cells is to be the target of the SpCell change.

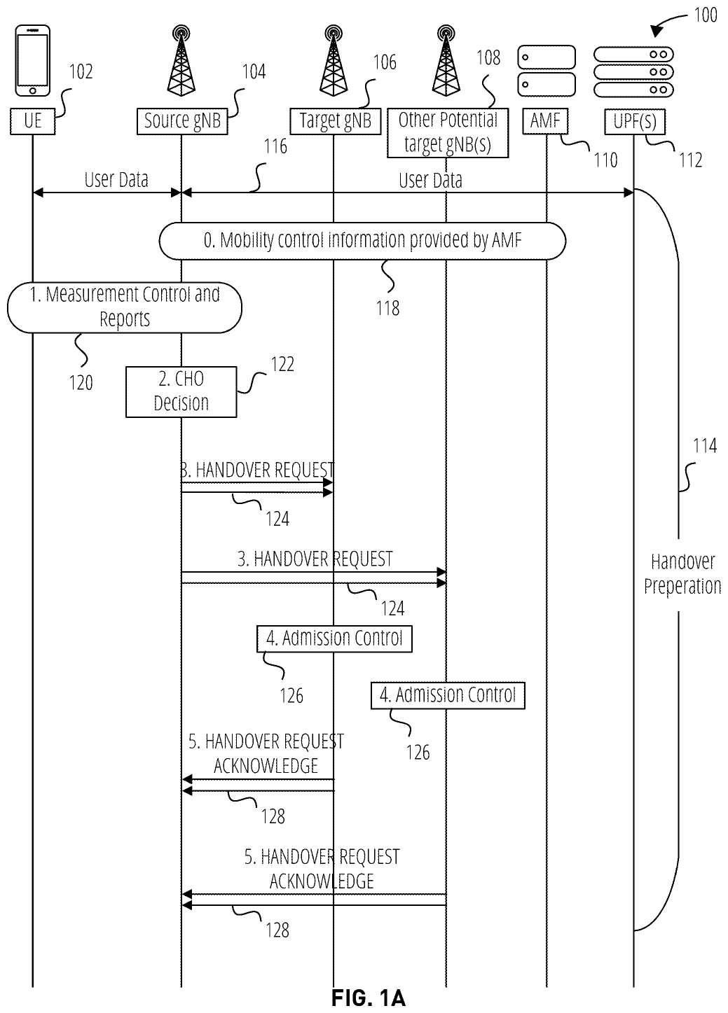

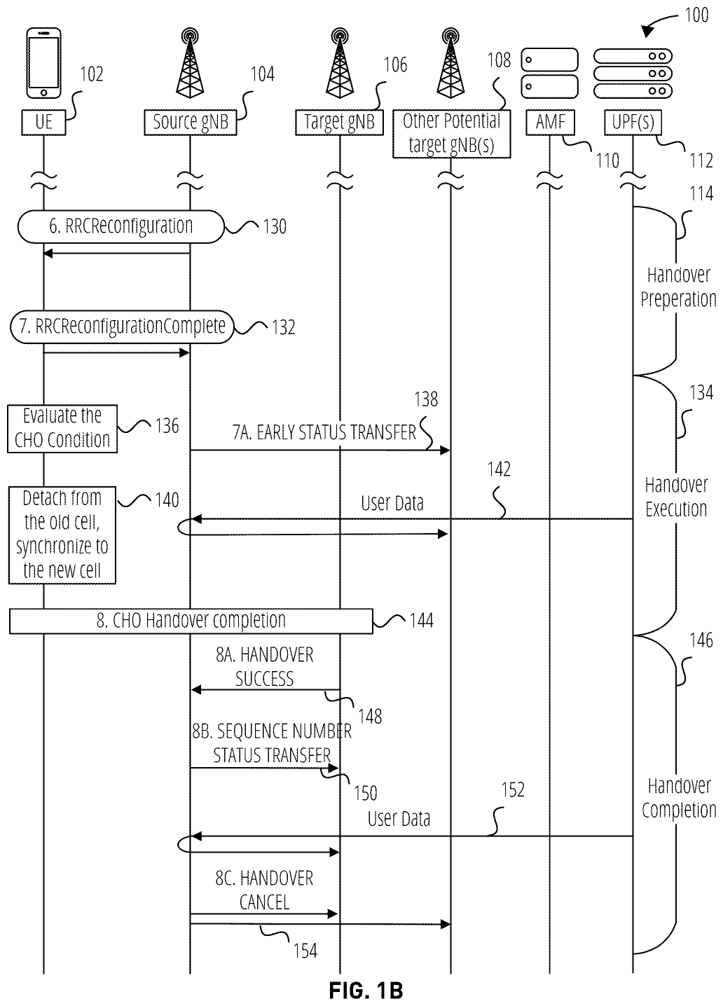

FIG. 1A and FIG. 1B together illustrate a flow diagram 100 for CHO that may be used in some wireless communications systems. The flow diagram 100 illustrates a wireless communication system that includes a UE 102, a source gNB 104, a target gNB 106, other potential target gNB(s) 108, an access and mobility management function (AMF) 110, and one or more user plane functions (UFP(s)) 112. As can be seen, the flow diagram 100 corresponds to an intra-AMF/UPF case.

As illustrated in FIG. 1A, the flow diagram 100 begins with the handover preparation phase 114. Presently, user data 116 is transported between the UE 102 and the source gNB 104 and between the source gNB 104 and the UFP(s) 112, as illustrated. The AMF 110 provides the source gNB 104 with mobility control information 118. Then, the source gNB 104 configures measurements at the UE 102, and the UE performs reporting, during the measurement control and reports 120. Based on the receipt of the measurement reporting, the source gNB 104 makes a CHO decision 122. Based on the CHO decision 122, the source gNB 104 sends handover requests 124 to other gNBs (in the flow diagram 100, both the target gNB 106 that will ultimately be selected as the target of the handover and other potential target gNB(s) 108 are illustrated as receiving the handover requests 124).

The other gNBs (e.g., the target gNB 106 and the other potential target gNB(s) 108) each perform admission control 126, and reply to the source gNB 104 with a handover request acknowledgement 128, including configuration of any CHO candidate cell(s) at that gNB.

FIG. 1B continues the flow diagram 100 discussed above in relation to FIG. 1A. The source gNB 104 sends the UE 102 a radio resource configuration (RRC) reconfiguration message 130 having the configuration for the CHO candidate cells. The UE 102 sends the source gNB 104 an RRC reconfiguration complete message 132.

The flow diagram 100 then enters the handover execution phase 134. The UE 102 evaluates 136 the CHO condition. Further, in some embodiments (e.g., where early data forwarding is used) the target gNB 106 sends the other potential target gNB(s) 108 an early status transfer message 138.

Then, the UE 102 detaches 140 from the old cell and synchronizes to a new cell (e.g., on the target gNB 106). As part of this process, the UE performs an evaluation of conditions on the candidate cell(s) and determines that the new cell (on the target gNB 106) meets the conditions and that it will accordingly handover to that cell. The configuration for that new cell is then applied at the UE.

Further, user data 142 is transported between the UFP(s) 112 and the target gNB 106 and/or the other potential target gNB(s) 108 via the source gNB 104. The CHO handover completion 144 occurs once the UE 102 becomes associated with the new cell on the source gNB 104 (and the UE 102 may send an attendant RRC reconfiguration complete message to the target gNB 106).

The flow diagram 100 then enters the handover completion phase 146. First, the target gNB 106 sends the source gNB 104 a handover success message 148. Then, the source gNB 104 sends the target gNB 106 a sequence number status transfer 150. User data 152 is transported between the UFP(s) 112 and the target gNB 106 via the source gNB 104. Finally, the source gNB 104 may send the target gNB 106 and/or the other potential target gNB(s) 108 a handover cancel message 154.

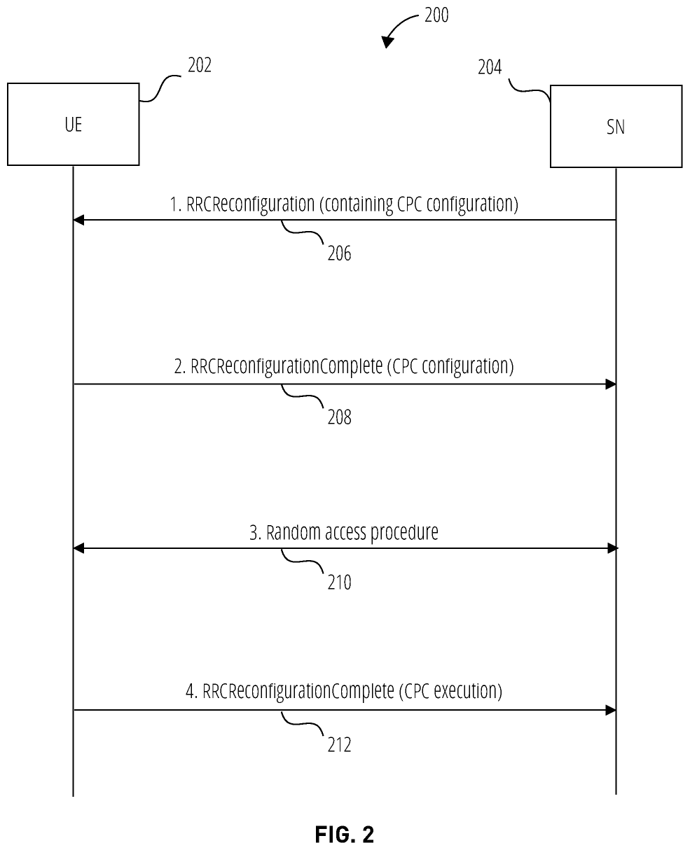

FIG. 2 illustrates a flow diagram 200 for CPC that may be used in some wireless communications systems. The flow diagram 200 illustrates a case where a secondary node (SN) 204 communicates directly with a UE 202 to effectuate the CPC.

First, the SN 204 sends the UE 202 an RRC reconfiguration message 206. This RRC reconfiguration message 206 may contain a CPC configuration for the UE to use. This CPC configuration may include one or more candidate cells for the CPC, as well as condition(s) that the UE is to use against those candidate cells as part of a CPC.

Then, the UE 202 sends the SN 204 an RRC reconfiguration complete message 208. The RRC reconfiguration complete message 208 may contain the CPC configuration that is being used by the UE (which may be, e.g., the CPC configuration provided to the UE in the RRC reconfiguration message 206).

Then, a random access procedure 210 is performed between the UE 202 and the SN 204. The random access procedure 210 may include a CPC by the UE 202 to one of the configured candidate cells at the SN 204 based on the configured condition(s) for the CPC.

Finally, upon completing the CPC successfully, the UE 202 sends an RRC reconfiguration complete message 212 to the SN 204 (and this RRC reconfiguration complete message 212 may indicate the execution of the CPC by the UE 202, as illustrated).

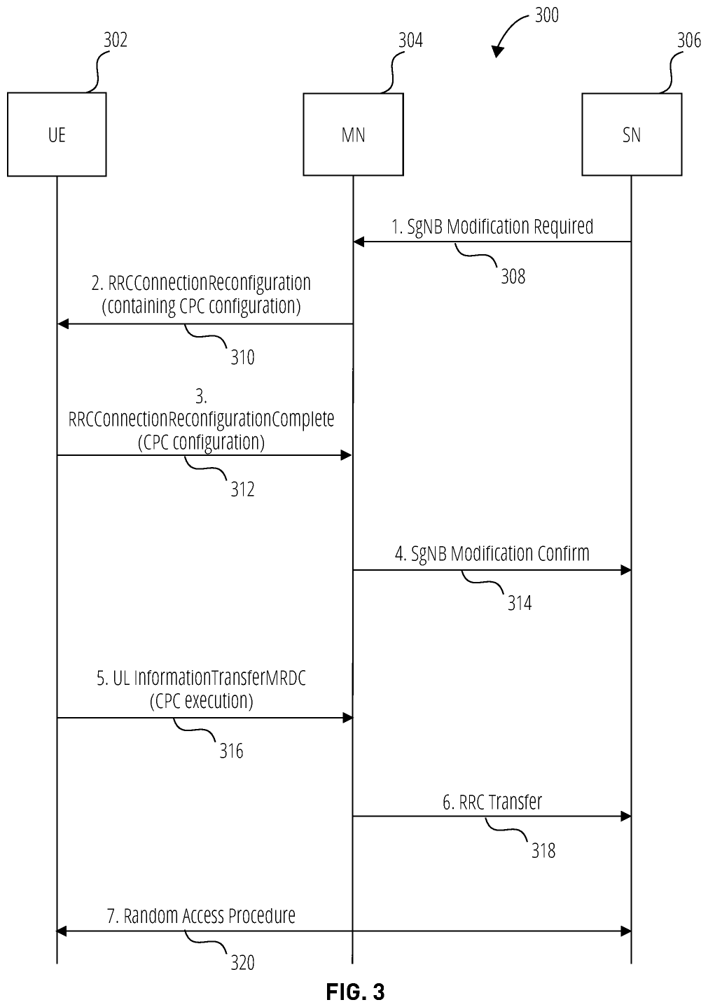

FIG. 3 illustrates a flow diagram 300 for a CPC that may be used in some wireless communications systems. The flow diagram 300 illustrates a case where an SN 306 communicates with a UE 302 through a master node (MN) 304 to effectuate the CPC.

First, the SN 306 sends the MN 304 a secondary gNB (SgNB) modification required message 308.

In response to the receipt of the SgNB modification required message 308 from the SN 306, the MN 304 sends the UE 302 an RRC connection reconfiguration message 310. This RRC connection reconfiguration message 310 may contain a CPC configuration for the UE to use. This CPC configuration may include one or more candidate cells for the CPC, as well as condition(s) that the UE is to use against those candidate cells as part of a CPC.

Then, the UE 302 sends the MN 304 an RRC connection reconfiguration complete message 312. The RRC connection reconfiguration complete message 312 may contain the CPC configuration that is being used by the UE (which may be, e.g., the CPC configuration provided to the UE in the RRC connection reconfiguration message 310)

The MN 304 then sends the SN 306 an SgNB modification confirm message 314.

The UE 302 then sends the MN 304 a UL information transfer multi-RAT dual connectivity (MRDC) message 316 (and this UL information transfer MRDC message 316 may indicate the execution of the CPC by the UE 302, as illustrated).

In response, the MN 304 then sends the SN 306 an RRC transfer message 318.

Finally, a random access procedure 320 is performed between the UE 302 and the SN 306. The random access procedure 320 may include a CPC by the UE 302 to one of the configured candidate cells at the SN 306 based on the configured condition(s) for the CPC.

When implementing a conditional SpCell change (e.g., a CHO in the manner described above in relation to FIG. 1A and FIG. 1B and/or a CPC in the manner described above in relation to FIG. 2 and/or FIG. 3), the UE may use one or more of the following criteria or optimizations to decide the best cell for a SpCell change as among multiple compliant cells respective to the applicable condition.

In some cases, the UE may compare the cells' reference signal received power (RSRP), reference signal received quality (RSRQ) and/or signal to interference and noise ratio (SINR) power values (and prefer, for example, cells having relatively higher values of one or more of these).

In some case, the UE may prefer intra-frequency SpCell change over inter-frequency SpCell change (e.g., because of a presumption of a higher relative success rate).

In some cases, the UE may prefer a cell having a relatively larger bandwidth over a cell having a relatively smaller bandwidth.

In some cases, the UE may prefer a cell using relatively more component carriers (CCs) then a cell using relatively fewer or no additional CCs. In cases, cells implementing carrier aggregation (CA) may be preferred over cells not implementing CA.

In some cases, the UE may prefer a cell in a relatively lower band versus a cell in a relatively higher band (or vice versa) based on application support needs as corresponding to appropriate bands.

In some cases, the UE may prefer cells based on carrier preference (e.g., a time division duplex (TDD) cell may be preferred over a frequency division duplex (FDD) cell, or vice versa).

In some cases, the UE may prefer a cell based on the needs of and/or criticality of the application that is being used. For example, for a mission critical application, the UE may prefer a cell where SpCell change success is deemed to be more likely than a SpCell change to another cell (e.g., the UE may prefer a cell of a relatively lower band versus a cell of a relatively higher band when it is deemed that handover to a low band cell is relatively more likely to be successful). In another example, the UE may prefer a relatively lower latency cell over a relatively higher latency cell if the application is a low latency application (for example, a cell using a relatively higher subcarrier spacing (SCS) of 30 kilohertz (kHz) may be preferred over a cell using a relatively lower SCS of 15 kHz).

In some cases, the UE may prefer a less congested cell over a more congested cell.

In some cases, the UE may prefer a cell having a relatively higher bandwidth and/or a cell using relatively more CCs (e.g., the UE may prefer an FR2 cell over an FR1 cell) in the case that an internet best effort application is active (e.g., corresponding to a download of large game/movie/etc.).

It is further contemplated that multiple subscriber identity module (MSIM) considerations may be used by the UE operating in an MSIM context to determine a preferred cell. For example, a UE operating in an MSIM context may prefer, for a first subscriber identity module (SIM), a cell on a band which is conflict free with a cell for the other SIM.

As discussed elsewhere herein, it is contemplated that any one or more of these preferences could be used in a CHO context and/or a CPC context, as described herein.

It is contemplated that these preferences could be used in networks implementing one or more of LTE, NR standalone (SA), E-UTRAN NR dual connectivity (ENDC), NR dual connectivity (NRDC), NR E-UTRAN dual connectivity (NE-DC), etc.

In some cases, a UE may delay a conditional SpCell change execution for a preferred candidate cell if a current serving cell quality is above certain threshold.

It is contemplated that the criteria proposed above can be weighted, combined, and/or selectively used to make the final decision regarding a conditional SpCell change.

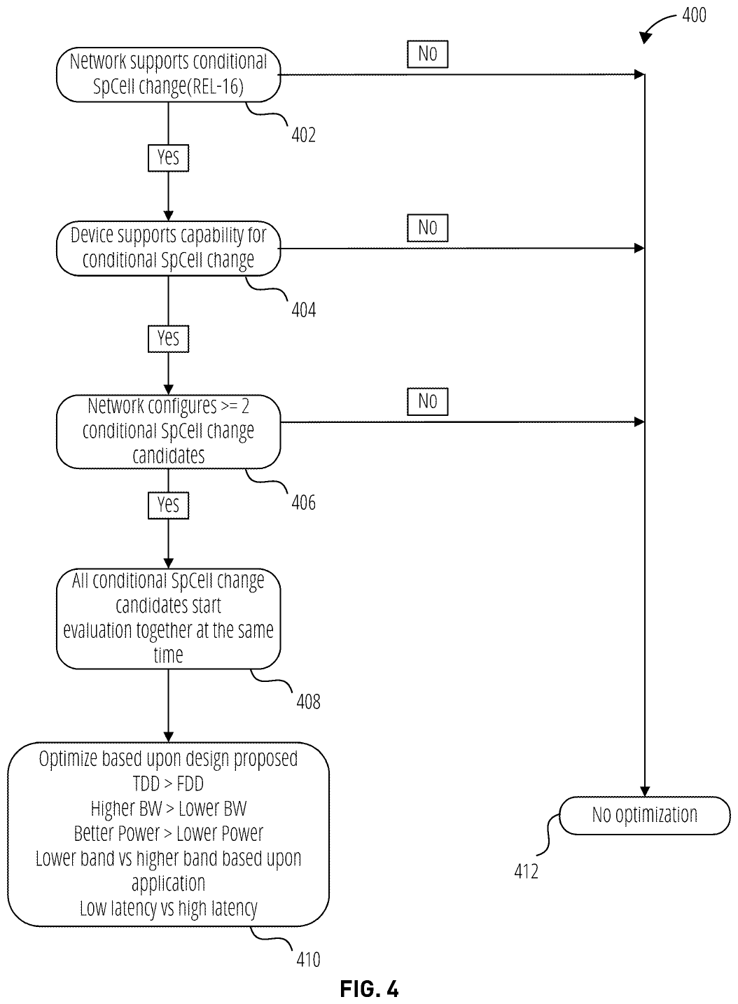

FIG. 4 illustrates a method 400 for optimizing a conditional SpCell change, according to embodiments herein. The method 400 includes determining 402 whether the network supports conditional SpCell change (e.g., Rel-16 CHO or Rel-16 CPC, as the case may be, as illustrated). If so, the method 400 proceeds to determining 404. If not, the method 400 proceeds to a determination 412 that no conditional SpCell change optimization is used.

The method 400 includes determining 404 whether the device supports a capability for the conditional SpCell change (e.g., Rel-16 CHO or Rel-16 CPC, as the case may be). If so, the method 400 proceeds to determining 406. If not, the method 400 proceeds to a determination 412 that no SpCell change optimization is used.

The method 400 includes determining 406 whether the network has configured greater than or equal to two (e.g., more than one) conditional SpCell change candidate cells. If so, the method 400 proceeds to starting 408. If not, the method 400 proceeds to a determination 412 that no conditional SpCell change optimization is used.

The method 400 includes starting 408 an evaluation of the conditional SpCell change candidate cells together at the same time. For example, it may be determined that multiple candidate cells are compliant with any condition for the conditional SpCell change, as is described herein. The method 400 then proceeds to optimizing 410.

The method 400 includes optimizing 410 the conditional SpCell change based on one or more criteria for selecting from the multiple conditional SpCell change candidate cells that meet the condition for the conditional SpCell change. For example, one or more of the criteria/preferences discussed herein may be used to select a cell from the multiple conditional SpCell change candidate cells meeting the condition with which to perform the SpCell change.

In some instances, it may be beneficial to identify whether a UE uses the conditional SpCell change optimizations described herein. In such cases, it may be that computer code and/or other technical documents relating details of the conditional SpCell change behavior implemented by the UE may not be readily available. In such cases, a manner of determining whether the UE uses conditional SpCell change optimizations described herein may include attaching the UE on an NR cell with conditional SpCell change capability support corresponding to both the UE side/and the network side. Then, the network may send a reconfiguration message to the UE that has a conditional SpCell change configuration. Two cells may be configured/provided such that a first cell (cell A) is of low bandwidth and/or FDD, etc., and such that a second cell (cell B) is of higher bandwidth and/or TDD and/or CA capable, etc. As seen, the capabilities of the cells may be changed/differentiated such that they correspond to an appropriately configured testing environment for a particular one or more conditional SpCell change optimizations that is being tested for, as these are described herein.

Then, cell A and cell B are configured such that each has channel conditions relative to the UE such that any conditions for a conditional SpCell change are satisfied for each cell.

The UE is then observed. In some cases, it may be that the UE triggers a random access channel (RACH) procedure to the cell that is associated with the preferred characteristic/criteria under a conditional SpCell change optimization as is discussed herein. Using the example configuration of cell A and cell B, in a case where CA capable cells and/or TDD cells are preferred, cell B may be selected. In such cases, if the UE uses the conditional SpCell change optimization/preference being tested for, then cell B will trigger RACH.

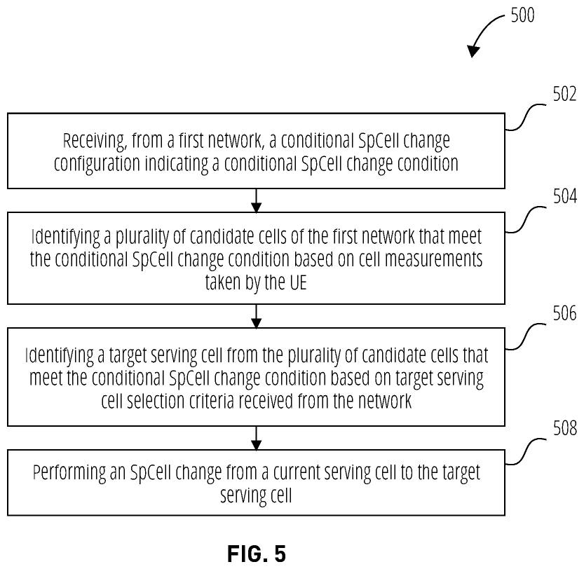

FIG. 5 illustrates a method 500 of a UE, according to embodiments herein. The method 500 includes receiving 502 from a first network, a conditional SpCell change configuration indicating a conditional SpCell change condition.

The method 500 further includes identifying 504 a plurality of candidate cells of the first network that meet the conditional SpCell change condition based on cell measurements taken by the UE.

The method 500 further includes identifying 506 a target serving cell from the plurality of candidate cells that meet the conditional SpCell change condition based on target serving cell selection criteria received from the network.

The method 500 further includes performing 508 an SpCell change from a current serving cell of the network to the target serving cell.

In some embodiments, the method 500 further includes receiving, from the network, a configured set of candidate cells, wherein the plurality of candidate cells that meet the conditional SpCell change condition is identified from the configured set of candidate cells.

In some embodiments of the method 500, the target serving cell selection criteria comprises prioritizing a candidate cell of the plurality of candidate cells with a highest measured power value.

In some embodiments of the method 500, the target serving cell selection criteria comprises prioritizing a candidate cell of the plurality of candidate cells that is an intra-frequency cell to the current serving cell.

In some embodiments of the method 500, the target serving cell selection criteria comprises prioritizing a candidate cell of the plurality of candidate cells having a largest bandwidth.

In some embodiments of the method 500, the target serving cell selection criteria comprises prioritizing a candidate cell of the plurality of candidate cells that uses a largest number of CCs.

In some embodiments of the method 500, the target serving cell selection criteria comprises prioritizing a candidate cell of the plurality of candidate cells that operates in a highest band.

In some embodiments of the method 500, the target serving cell selection criteria comprises prioritizing a candidate cell of the plurality of candidate cells that operates in a lowest band.

In some embodiments of the method 500, the target serving cell selection criteria comprises prioritizing a candidate cell of the plurality of candidate cells that is a TDD cell.

In some embodiments of the method 500, the target serving cell selection criteria comprises prioritizing a candidate cell of the plurality of candidate cells that is a FDD cell.

In some embodiments of the method 500, the target serving cell selection criteria comprises prioritizing a candidate cell of the plurality of candidate cells that is most useful for an application being used at the UE.

In some embodiments of the method 500, the target serving cell selection criteria comprises prioritizing a candidate cell of the plurality of candidate cells that is a low latency cell.

In some embodiments of the method 500, the target serving cell selection criteria comprises prioritizing a candidate cell of the plurality of candidate cells that is the least congested.

In some embodiments, the method 500 further includes identifying that an internet best effort application is being used at the UE, and, in response to the identification that the internet best effort application is being used, the target serving cell selection criteria comprises prioritizing a candidate cell of the plurality of candidate cells that comprises one or more of a largest bandwidth and a largest number CCs.

In some embodiments of the method 500, the target serving cell selection criteria comprises prioritizing a candidate cell of the plurality of candidate cells that is on a band that is not used by a second network operable with the UE.

In some embodiments, the method 500 further includes determining that the quality of the current serving cell is below a quality threshold, and the SpCell change is performed in response to the determination that the quality of the current serving cell is below the quality threshold.

In some embodiments of the method 500, the target serving cell selection criteria comprises prioritizing a candidate cell of the plurality of candidate cells based on a combination of a measured power value of the candidate cell and a number of CCs used by the candidate cell.

In some embodiments, the method 500 further includes identifying that an internet best effort application being used at the UE, and, in response to the identifying that the internet best effort application is being used, the target serving cell selection criteria comprises prioritizing a candidate cell of the plurality of candidate cells based on a combination of a bandwidth used by the candidate cell and a number component carriers (CCs) used by that candidate cell.

In some embodiments of the method 500, the SpCell change comprises a handover corresponding to an MCG.

In some embodiments of the method 500, the SpCell change comprises a change of a PSCell.

Embodiments contemplated herein include an apparatus comprising means to perform one or more elements of the method 500. This apparatus may be, for example, an apparatus of a UE (such as a wireless device 702 that is a UE, as described herein).

Embodiments contemplated herein include one or more non-transitory computer-readable media comprising instructions to cause an electronic device, upon execution of the instructions by one or more processors of the electronic device, to perform one or more elements of the method 500. This non-transitory computer-readable media may be, for example, a memory of a UE (such as a memory 706 of a wireless device 702 that is a UE, as described herein).

Embodiments contemplated herein include an apparatus comprising logic, modules, or circuitry to perform one or more elements of the method 500. This apparatus may be, for example, an apparatus of a UE (such as a wireless device 702 that is a UE, as described herein).

Embodiments contemplated herein include an apparatus comprising: one or more processors and one or more computer-readable media comprising instructions that, when executed by the one or more processors, cause the one or more processors to perform one or more elements of the method 500. This apparatus may be, for example, an apparatus of a UE (such as a wireless device 702 that is a UE, as described herein).

Embodiments contemplated herein include a signal as described in or related to one or more elements of the method 500.

Embodiments contemplated herein include a computer program or computer program product comprising instructions, wherein execution of the program by a processor is to cause the processor to carry out one or more elements of the method 500. The processor may be a processor of a UE (such as a processor(s) 704 of a wireless device 702 that is a UE, as described herein). These instructions may be, for example, located in the processor and/or on a memory of the UE (such as a memory 706 of a wireless device 702 that is a UE, as described herein).

Embodiments contemplated herein include an apparatus comprising means to perform one or more elements of the method 500. This apparatus may be, for example, an apparatus of a base station (such as a network device 718 that is a base station, as described herein).

Embodiments contemplated herein include one or more non-transitory computer-readable media comprising instructions to cause an electronic device, upon execution of the instructions by one or more processors of the electronic device, to perform one or more elements of the method 500. This non-transitory computer-readable media may be, for example, a memory of a base station (such as a memory 722 of a network device 718 that is a base station, as described herein).

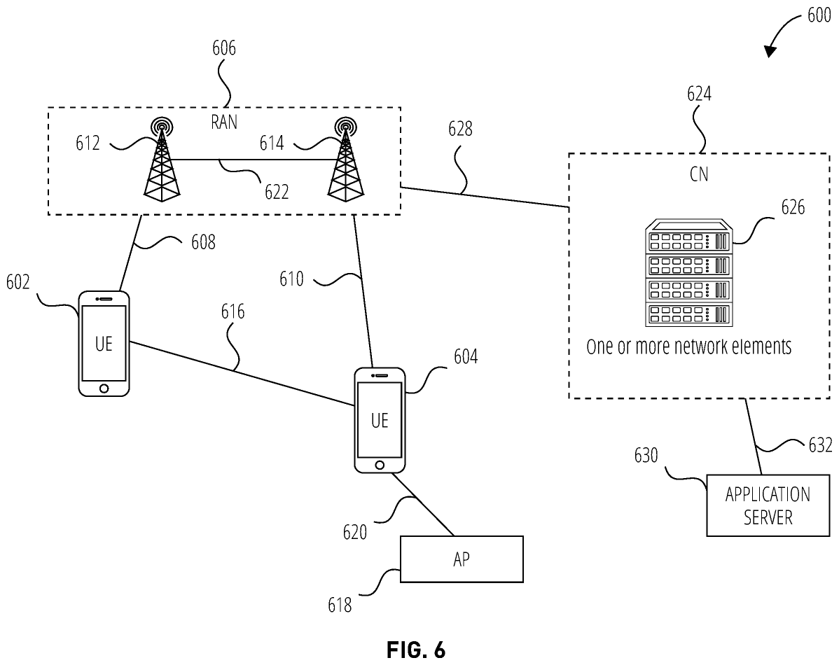

FIG. 6 illustrates an example architecture of a wireless communication system 600, according to embodiments disclosed herein. The following description is provided for an example wireless communication system 600 that operates in conjunction with the LTE system standards and/or 5G or NR system standards as provided by 3GPP technical specifications.

As shown by FIG. 6, the wireless communication system 600 includes UE 602 and UE 604 (although any number of UEs may be used). In this example, the UE 602 and the UE 604 are illustrated as smartphones (e.g., handheld touchscreen mobile computing devices connectable to one or more cellular networks), but may also comprise any mobile or non-mobile computing device configured for wireless communication.

The UE 602 and UE 604 may be configured to communicatively couple with a RAN 606. In embodiments, the RAN 606 may be NG-RAN, E-UTRAN, etc. The UE 602 and UE 604 utilize connections (or channels) (shown as connection 608 and connection 610, respectively) with the RAN 606, each of which comprises a physical communications interface. The RAN 606 can include one or more base stations (such as base station 612 and base station 614) that enable the connection 608 and connection 610.

In this example, the connection 608 and connection 610 are air interfaces to enable such communicative coupling, and may be consistent with RAT(s) used by the RAN 606, such as, for example, an LTE and/or NR.

In some embodiments, the UE 602 and UE 604 may also directly exchange communication data via a sidelink interface 616. The UE 604 is shown to be configured to access an access point (shown as AP 618) via connection 620. By way of example, the connection 620 can comprise a local wireless connection, such as a connection consistent with any IEEE 802.11 protocol, wherein the AP 618 may comprise a Wi-Fi® router. In this example, the AP 618 may be connected to another network (for example, the Internet) without going through a CN 624.

In embodiments, the UE 602 and UE 604 can be configured to communicate using orthogonal frequency division multiplexing (OFDM) communication signals with each other or with the base station 612 and/or the base station 614 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 612 or base station 614 may be implemented as one or more software entities running on server computers as part of a virtual network. In addition, or in other embodiments, the base station 612 or base station 614 may be configured to communicate with one another via interface 622. In embodiments where the wireless communication system 600 is an LTE system (e.g., when the CN 624 is an EPC), the interface 622 may be an X2 interface. The X2 interface may be defined between two or more base stations (e.g., two or more eNBs and the like) that connect to an EPC, and/or between two eNBs connecting to the EPC. In embodiments where the wireless communication system 600 is an NR system (e.g., when CN 624 is a 5GC), the interface 622 may be an Xn interface. The Xn interface is defined between two or more base stations (e.g., two or more gNBs and the like) that connect to 5GC, between a base station 612 (e.g., a gNB) connecting to 5GC and an eNB, and/or between two eNBs connecting to 5GC (e.g., CN 624).

The RAN 606 is shown to be communicatively coupled to the CN 624. The CN 624 may comprise one or more network elements 626, which are configured to offer various data and telecommunications services to customers/subscribers (e.g., users of UE 602 and UE 604) who are connected to the CN 624 via the RAN 606. The components of the CN 624 may be implemented in one physical device or separate physical devices including components to read and execute instructions from a machine-readable or computer-readable medium (e.g., a non-transitory machine-readable storage medium).

In embodiments, the CN 624 may be an EPC, and the RAN 606 may be connected with the CN 624 via an S1 interface 628. In embodiments, the S1 interface 628 may be split into two parts, an S1 user plane (S1-U) interface, which carries traffic data between the base station 612 or base station 614 and a serving gateway (S-GW), and the S1-MME interface, which is a signaling interface between the base station 612 or base station 614 and mobility management entities (MMEs).

In embodiments, the CN 624 may be a 5GC, and the RAN 606 may be connected with the CN 624 via an NG interface 628. In embodiments, the NG interface 628 may be split into two parts, an NG user plane (NG-U) interface, which carries traffic data between the base station 612 or base station 614 and a user plane function (UPF), and the S1 control plane (NG-C) interface, which is a signaling interface between the base station 612 or base station 614 and access and mobility management functions (AMFs).

Generally, an application server 630 may be an element offering applications that use internet protocol (IP) bearer resources with the CN 624 (e.g., packet switched data services). The application server 630 can also be configured to support one or more communication services (e.g., VoIP sessions, group communication sessions, etc.) for the UE 602 and UE 604 via the CN 624. The application server 630 may communicate with the CN 624 through an IP communications interface 632.

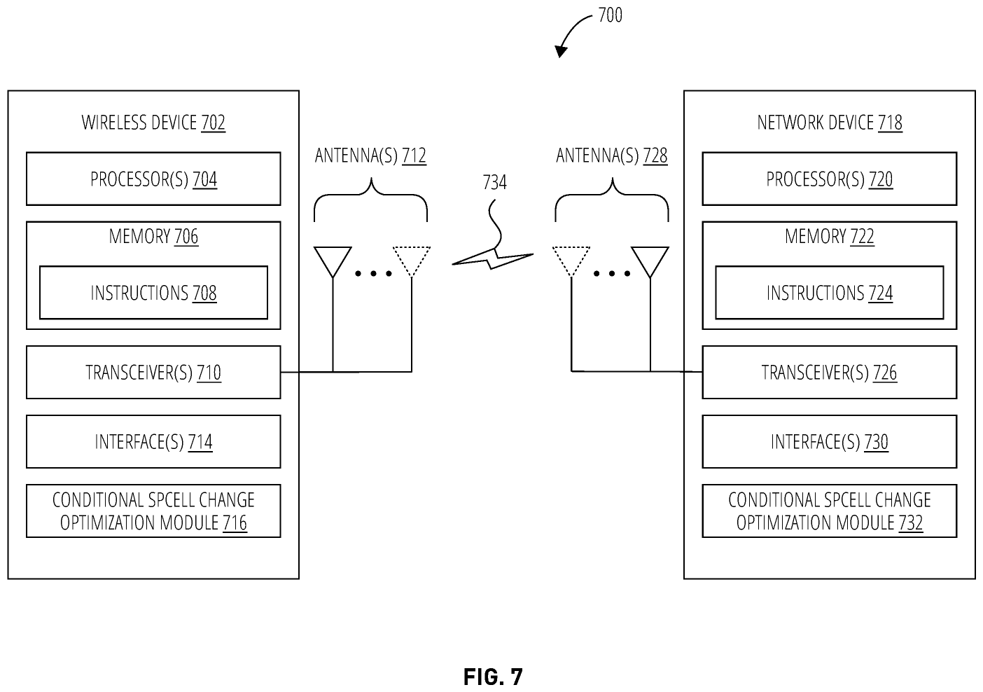

FIG. 7 illustrates a system 700 for performing signaling 734 between a wireless device 702 and a network device 718, according to embodiments disclosed herein. The system 700 may be a portion of a wireless communications system as herein described. The wireless device 702 may be, for example, a UE of a wireless communication system. The network device 718 may be, for example, a base station (e.g., an eNB or a gNB) of a wireless communication system.

The wireless device 702 may include one or more processor(s) 704. The processor(s) 704 may execute instructions such that various operations of the wireless device 702 are performed, as described herein. The processor(s) 704 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 702 may include a memory 706. The memory 706 may be a non-transitory computer-readable storage medium that stores instructions 708 (which may include, for example, the instructions being executed by the processor(s) 704). The instructions 708 may also be referred to as program code or a computer program. The memory 706 may also store data used by, and results computed by, the processor(s) 704.

The wireless device 702 may include one or more transceiver(s) 710 that may include radio frequency (RF) transmitter and/or receiver circuitry that use the antenna(s) 712 of the wireless device 702 to facilitate signaling (e.g., the signaling 734) to and/or from the wireless device 702 with other devices (e.g., the network device 718) according to corresponding RATs.

The wireless device 702 may include one or more antenna(s) 712 (e.g., one, two, four, or more). For embodiments with multiple antenna(s) 712, the wireless device 702 may leverage the spatial diversity of such multiple antenna(s) 712 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 702 may be accomplished according to precoding (or digital beamforming) that is applied at the wireless device 702 that multiplexes the data streams across the antenna(s) 712 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 702 may implement analog beamforming techniques, whereby phases of the signals sent by the antenna(s) 712 are relatively adjusted such that the (joint) transmission of the antenna(s) 712 can be directed (this is sometimes referred to as beam steering).

The wireless device 702 may include one or more interface(s) 714. The interface(s) 714 may be used to provide input to or output from the wireless device 702. For example, a wireless device 702 that is a UE may include interface(s) 714 such as microphones, speakers, a touchscreen, buttons, and the like in order to allow for input and/or output to the UE by a user of the UE. Other interfaces of such a UE may be made up of made up of transmitters, receivers, and other circuitry (e.g., other than the transceiver(s) 710/antenna(s) 712 already described) that allow for communication between the UE and other devices and may operate according to known protocols (e.g., Wi-Fi®, Bluetooth®, and the like).

The wireless device 702 may include a conditional SpCell change optimization module 716. The conditional SpCell change optimization module 716 may be implemented via hardware, software, or combinations thereof. For example, the conditional SpCell change optimization module 716 may be implemented as a processor, circuit, and/or instructions 708 stored in the memory 706 and executed by the processor(s) 704. In some examples, the conditional SpCell change optimization module 716 may be integrated within the processor(s) 704 and/or the transceiver(s) 710. For example, the conditional SpCell change optimization module 716 may be implemented by a combination of software components (e.g., executed by a DSP or a general processor) and hardware components (e.g., logic gates and circuitry) within the processor(s) 704 or the transceiver(s) 710.

The conditional SpCell change optimization module 716 may be used for various aspects of the present disclosure, for example, aspects of FIG. 1A through FIG. 5. The conditional SpCell change optimization module 716 is configured to, for example, act according to one or more of the criteria/preferences for conditional SpCell change optimizations, as discussed herein.

The network device 718 may include one or more processor(s) 720. The processor(s) 720 may execute instructions such that various operations of the network device 718 are performed, as described herein. The processor(s) 720 may include one or more baseband processors implemented using, for example, a CPU, a DSP, an ASIC, a controller, an FPGA device, another hardware device, a firmware device, or any combination thereof configured to perform the operations described herein.

The network device 718 may include a memory 722. The memory 722 may be a non-transitory computer-readable storage medium that stores instructions 724 (which may include, for example, the instructions being executed by the processor(s) 720). The instructions 724 may also be referred to as program code or a computer program. The memory 722 may also store data used by, and results computed by, the processor(s) 720.

The network device 718 may include one or more transceiver(s) 726 that may include RF transmitter and/or receiver circuitry that use the antenna(s) 728 of the network device 718 to facilitate signaling (e.g., the signaling 734) to and/or from the network device 718 with other devices (e.g., the wireless device 702) according to corresponding RATs.

The network device 718 may include one or more antenna(s) 728 (e.g., one, two, four, or more). In embodiments having multiple antenna(s) 728, the network device 718 may perform MIMO, digital beamforming, analog beamforming, beam steering, etc., as has been described.

The network device 718 may include one or more interface(s) 730. The interface(s) 730 may be used to provide input to or output from the network device 718. For example, a network device 718 that is a base station may include interface(s) 730 made up of transmitters, receivers, and other circuitry (e.g., other than the transceiver(s) 726/antenna(s) 728 already described) that enables the base station to communicate with other equipment in a core network, and/or that enables the base station to communicate with external networks, computers, databases, and the like for purposes of operations, administration, and maintenance of the base station or other equipment operably connected thereto.

The network device 718 may include a conditional SpCell change optimization module 732. The conditional SpCell change optimization module 732 may be implemented via hardware, software, or combinations thereof. For example, the conditional SpCell change optimization module 732 may be implemented as a processor, circuit, and/or instructions 724 stored in the memory 722 and executed by the processor(s) 720. In some examples, the conditional SpCell change optimization module 7322 may be integrated within the processor(s) 720 and/or the transceiver(s) 726. For example, the conditional SpCell change optimization module 732 may be implemented by a combination of software components (e.g., executed by a DSP or a general processor) and hardware components (e.g., logic gates and circuitry) within the processor(s) 720 or the transceiver(s) 726.

The conditional SpCell change optimization module 732 may be used for various aspects of the present disclosure, for example, aspects of FIG. 1A through FIG. 5. The conditional SpCell change optimization module 732 is configured to, for example, act according to one or more of the criteria/preferences for conditional SpCell change optimizations, as discussed herein.

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A user equipment (UE), comprising:
one or more processors; and
a memory storing instructions that, when executed by the one or more processors, configure the UE to:
receive, from a first network, a conditional special cell (SpCell) change configuration indicating a conditional SpCell change condition;
identify a plurality of candidate cells of the first network that meet the conditional SpCell change condition based on cell measurements taken by the UE;
identify a target serving cell from the plurality of candidate cells that meet the conditional SpCell change condition based on target serving cell selection criteria received from the network; and
perform an SpCell change from a current serving cell to the target serving cell.

2. The UE of claim 1, wherein the instructions, when executed by the one or more processors, further configure the UE to receive, from the network, a configured set of candidate cells, wherein the plurality of candidate cells that meet the conditional SpCell change condition is identified from the configured set of candidate cells.

3. The UE of claim 1, wherein the target serving cell selection criteria comprises prioritizing a candidate cell of the plurality of candidate cells with a highest measured power value.

4. The UE of claim 1, wherein the target serving cell selection criteria comprises prioritizing a candidate cell of the plurality of candidate cells that is an intra-frequency cell to the current serving cell.

5. The UE of claim 1, wherein the target serving cell selection criteria comprises prioritizing a candidate cell of the plurality of candidate cells having a largest bandwidth.

6. The UE of claim 1, wherein the target serving cell selection criteria comprises prioritizing a candidate cell of the plurality of candidate cells that uses a largest number of component carriers (CCs).

7. The UE of claim 1, wherein the target serving cell selection criteria comprises prioritizing a candidate cell of the plurality of candidate cells that operates in a highest band.

8. The UE of claim 1, wherein the target serving cell selection criteria comprises prioritizing a candidate cell of the plurality of candidate cells that is a FDD cell.

9. The UE of claim 1, wherein the target serving cell selection criteria comprises prioritizing a candidate cell of the plurality of candidate cells that is most useful for an application being used at the UE.

10. The UE of claim 1, wherein the target serving cell selection criteria comprises prioritizing a candidate cell of the plurality of candidate cells that is a low latency cell.

11. The UE of claim 1, wherein the target serving cell selection criteria comprises prioritizing a candidate cell of the plurality of candidate cells that is the least congested.

12. The UE of claim 1, wherein the instructions, when executed by the one or more processors, further configure the UE to identify that an internet best effort application is being used at the UE; and
wherein, in response to the identification that the internet best effort application is being used, the target serving cell selection criteria comprises prioritizing a candidate cell of the plurality of candidate cells that comprises one or more of:
a largest bandwidth; and
a largest number component carriers (CCs).

13. The UE of claim 1, wherein the target serving cell selection criteria comprises prioritizing a candidate cell of the plurality of candidate cells that is on a band that is not used by a second network operable with the UE.

14. The UE of claim 1, wherein the instructions, when executed by the one or more processors, further configure the UE to determine that a quality of the current serving cell is below a quality threshold, and wherein the SpCell change is performed in response to the determination that the quality of the current serving cell is below the quality threshold.

15. A method of a user equipment (UE), comprising:
receiving, from a first network, a conditional special cell (SpCell) change configuration indicating a conditional SpCell change condition;
identifying a plurality of candidate cells of the first network that meet the conditional SpCell change condition based on cell measurements taken by the UE;
identifying a target serving cell from the plurality of candidate cells that meet the conditional SpCell change condition based on target serving cell selection criteria received from the network; and
performing an SpCell change from a current serving cell of the network to the target serving cell.

16. The method of claim 15, wherein the target serving cell selection criteria comprises prioritizing a candidate cell of the plurality of candidate cells based on a combination of:
a measured power value of the candidate cell; and
a number of component carriers (CCs) used by the candidate cell.

17. The method of claim 15, further comprising identifying that an internet best effort application being used at the UE; and
wherein, in response to the identifying that the internet best effort application is being used, the target serving cell selection criteria comprises prioritizing a candidate cell of the plurality of candidate cells based on a combination of:
a bandwidth used by the candidate cell; and
a number component carriers (CCs) used by that candidate cell.

18. The method of claim 15, wherein the SpCell change comprises a handover corresponding to a master cell group (MCG).

19. The method of claim 15, wherein the SpCell change comprises a change of a primary cell of a secondary cell group (PSCell).

20. A non-transitory computer-readable storage medium including instructions that, when executed by one or more processors of a user equipment (UE) cause the UE to:
receive, from a first network, a conditional special cell (SpCell) change configuration indicating a conditional SpCell change condition;
identify a plurality of candidate cells of the first network that meet the conditional SpCell change condition based on cell measurements taken by the UE;
identify a target serving cell from the plurality of candidate cells that meet the conditional SpCell change condition based on target serving cell selection criteria received from the network; and
perform an SpCell change from a current serving cell of the network to the target serving cell.
